(19) United States
(12) Patent Application Publication
(10) Pub. No.: US 2025/0153115 A1
(43) Pub. Date: May 15, 2025

(54) POLYELECTROLYTE-CROSSLINKED GRAPHENE OXIDE-BASED CATION EXCHANGE MEMBRANE AND METHOD OF MANUFACTURING THE SAME

(71) Applicant: Korea University Research and Business Foundation, Seoul (KR)

(72) Inventors: Chang Soo HAN, Seoul (KR); Heon Seung CHAE, Seoul (KR)

(73) Assignee: Korea University Research and Business Foundation, Seoul (KR)

(21) Appl. No.: 18/935,884

(22) Filed: Nov. 4, 2024

(30) Foreign Application Priority Data
Nov. 2, 2023 (KR) 10-2023-0149829
Feb. 5, 2024 (KR) 10-2024-0017196

(51) Int. Cl. B01D 69/12; B01D 71/02; B01D 71/40; B01J 39/19

(52) U.S. Cl. CPC B01D 69/1214; B01D 69/1216; B01D 71/0211; B01D 71/401; B01J 39/19; B01D 2325/04; B01D 2325/42

(57) ABSTRACT

Disclosed is a cation exchange membrane that has a structure in which a polymer is cross-linked to graphene oxide and can selectively restrict the permeation of anions. According to an embodiment of the present disclosure, a cation exchange membrane that has higher cation selectivity even at a thin thickness by cross-linking a polymer to graphene oxide and is not easily redispersed in water can be provided. In addition, the cation exchange membrane according to an embodiment of the present disclosure is much thinner than general commercial ion exchange membranes, thereby having low electrical resistance and flexibility. Accordingly, when used in desalination devices, fuel cells, etc., it can reduce the volumes and manufacturing costs of the products.

### BACKGROUND OF THE DISCLOSURE

### Field of the Disclosure

The present disclosure relates to a polymer-crosslinked composite cation exchange membrane and a method of manufacturing the same, and more particularly to a composite cation exchange membrane based on a polymer-crosslinked graphene oxide and a method of manufacturing the same. A cation exchange membrane having such a composite structure can exhibit higher cation selectivity.

### Description of the Related Art

With the technological advancements worldwide, water shortage and energy demand have become important issues in recent decades. Membrane technology is considered one of the promising methods for water treatment and recovery, and is also considered a key element of eco-friendly energy conversion technologies such as fuel cells and reverse electrodialysis. Accordingly, research on ion exchange membranes, a technology that selectively controls the permeation of ions, is being emphasized.

Ion exchange membranes can selectively allow the permeation of ions (counter-ions) with the opposite charge while blocking the permeation of ions (co-ions) with the same polarity, and are classified into an anion exchange membrane and a cation exchange membrane depending on the type of ion exchanger.

A cation exchange membrane (CEM) has anionic species (anionic groups) such as —SO₃⁻, —COO⁻, PO₃²⁻, PO₃H⁻, and —C₆H₄O⁻, so cations can easily pass through the CEM due to the attraction force between the cations, while anions have difficulty in passing through the CEM due to the repulsion force between the same negative charges.

Graphene oxide (GO) is a two-dimensional (2D) nanomaterial made by oxidizing graphene, and contains oxygen functional groups such as epoxy, hydroxyl, and carboxyl groups. Unlike hydrophobic graphene, graphene oxide has hydrophilicity due to these functional groups and can be well dispersed in water. In particular, the size of graphene oxide flakes can be adjusted from several nanometers to millimeters and the graphene oxide flakes can be mass-produced, so they have potential applications in many fields such as electrical sensors, composite materials, clean energy devices, biology, and medicine.

Graphene oxide membranes are arranged at nano-level gaps from regions of graphene sheets that ions cannot pass through, and, at the same time, have channels that ions can pass through due to oxygen functional groups, and have negative charges due to the presence of oxygen functional groups to restrict the permeation of ions with the same negative charges, so they can be used as cation exchange membranes on their own.

Graphene oxide-based ion exchange membranes are generally manufactured to a thickness of 10 μm or less, and thus, cost reduction effects can be expected. However, compared to commercialized ion exchange membranes made of a polymer material, they have the problems of lacking ion exchangers, low selectivity for cations, and the problem that the graphene oxide membrane is easily dispersed in water and it is difficult to maintain mechanical stability. Therefore, graphene oxide alone is not sufficient to be used as a cation exchange membrane.

### RELATED ART DOCUMENT

### Patent Document

Korean Patent No. 10-1825323, entitled “ION EXCHANGE MEMBRANE”

### SUMMARY OF THE DISCLOSURE

Therefore, the present disclosure has been made in view of the above problems, and it is an object of the present disclosure to provide a composite cation exchange membrane that can improve problems, such as the lack of ion exchangers, low selectivity for cations, and ease dispersion of graphene oxide membranes in water, of existing cation exchange membranes.

It is another object of the present disclosure to produce a graphene oxide composite in which an interlayer spacing between graphene oxides is the smallest but allows ions to move therethrough, and to apply the graphene oxide composite to a composite cation exchange membrane.

In accordance with an aspect of the present disclosure, the above and other objects can be accomplished by the provision of a composite cation exchange membrane including a graphene oxide composite, wherein the graphene oxide composite includes two graphene oxides and a polymer arranged between the graphene oxides.

According to an embodiment, the polymer may be cross-linked onto the two graphene oxides, wherein the cross-linking is a covalent bond between a diamine grafted onto the graphene oxide and a cross-linking agent bonded to the polymer.

According to an embodiment, the polymer may include a carboxyl group, wherein the cross-linking agent is bonded to the carboxyl group.

According to an embodiment, the composite cation exchange membrane may include the graphene oxide composite in multiple layers.

According to an embodiment, the composite cation exchange membrane may have a thickness of 5 μm to 10 μm.

According to an embodiment, a spacing between the two graphene oxides may be 0.35 nm to 1 nm.

According to an embodiment, the polymer may have an average molecular weight of 1000 g/mol to 3000 g/mol.

According to an embodiment, the polymer may include an ion exchanger to control the cation selectivity of the composite cation exchange membrane.

According to an embodiment, the two graphene oxides may be reduced graphene oxides, and a composite cation exchange membrane including the reduced graphene oxides may have controllable water dispersibility.

In accordance with another aspect of the present disclosure, provided is a method of manufacturing a composite cation exchange membrane, the method including: manufacturing diamine-grafted graphene oxide by reacting diamine in a graphene oxide solution; manufacturing a cross-linking agent-bonded polymer by reacting a carboxyl group-containing polymer with a cross-linking agent; manufacturing a polymer-crosslinked graphene oxide by stirring the diamine-grafted graphene oxide and the cross-linking agent-bonded polymer; and manufacturing a cation exchange membrane by forming the polymer-crosslinked graphene oxide into a thin membrane.

According to an embodiment, in the manufacturing of the diamine-grafted graphene oxide, the graphene oxide solution may be stirred and reacted with the diamine at a concentration of 0.1 mM to 1 mM for 30 minutes to 1 hour.

According to an embodiment, in the manufacturing of the diamine-grafted graphene oxide, an epoxide of the graphene oxide may be bonded to the diamine through a ring-opening reaction.

According to an embodiment, after the manufacturing of the polymer-crosslinked graphene oxide, purifying the polymer-crosslinked graphene oxide may be further included.

According to an embodiment, in the manufacturing of the cation exchange membrane, the forming of the polymer-crosslinked graphene oxide into a thin membrane may be performed by one process selected from among natural sedimentation, electro-sedimentation, vacuum filtration method, bar coating, spray coating, dip coating and slot dye coating.

According to an embodiment, in the manufacturing of the cation exchange membrane, a composite cation exchange membrane may be manufactured by vacuum-filtering the polymer-crosslinked graphene oxide on a porous membrane, wherein the porous membrane is one or more selected from among an anodic aluminum oxide membrane, a polyester sulfone membrane and a mixed cellulose ester membrane.

According to an embodiment, after the manufacturing of the cation exchange membrane, reducing the graphene oxide by heat-treating the cation exchange membrane may be further included.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 illustrates a schematic diagram of a graphene oxide-based cation exchange membrane.

FIG. 2 illustrates a process of manufacturing graphene oxide cross-linked with a polymer electrolyte.

FIG. 3 illustrates a process of manufacturing a cation exchange membrane.

FIGS. 4A and 4B illustrate a graphene oxide-based cation exchange membrane cross-linked with a polymer electrolyte.

FIGS. 5A and 5B illustrate the redispersion evaluation result of a cation exchange membrane after 24 hours in water.

FIG. 6 illustrates the result of graphene oxide and graphene oxide cross-linked with a polymer electrolyte, obtained by X-ray photoelectron spectroscopy.

FIG. 7A illustrates the results of graphene oxide and graphene oxide cross-linked with a polymer electrolyte, obtained by infrared spectroscopy.

FIG. 7B illustrates the result of Example 1 (referred to as a polymer cross-linked graphene oxide) again, obtained by X-ray diffraction.

FIG. 8 illustrates the results of a graphene oxide membrane grafted with graphene oxide and diamine and a graphene oxide cross-linked with a polymer electrolyte, obtained by X-ray diffraction analysis.

### DETAILED DESCRIPTION OF THE DISCLOSURE

The present disclosure will now be described more fully with reference to the accompanying drawings and contents disclosed in the drawings. However, the present disclosure should not be construed as limited to the exemplary embodiments described herein.

The terms used in the present specification are used to explain a specific exemplary embodiment and not to limit the present inventive concept. Thus, the expression of singularity in the present specification includes the expression of plurality unless clearly specified otherwise in context. It will be further understood that the terms “comprise” and/or “comprising”, when used in this specification, specify the presence of stated components, steps, operations, and/or elements, but do not preclude the presence or addition of one or more other components, steps, operations, and/or elements thereof.

It should not be understood that arbitrary aspects or designs disclosed in “embodiments”, “examples”, “aspects”, etc. used in the specification are more satisfactory or advantageous than other aspects or designs.

In addition, the expression “or” means “inclusive or” rather than “exclusive or”. That is, unless otherwise mentioned or clearly inferred from context, the expression “x uses a or b” means any one of natural inclusive permutations.

In addition, as used in the description of the disclosure and the appended claims, the singular forms “a”, “an” and “the” are intended to include the plural forms as well, unless context clearly indicates otherwise.

Further, when an element such as a layer, a film, a region, and a constituent is referred to as being “on” another element, the element can be directly on another element or an intervening element can be present.

A composite cation exchange membrane according to the present disclosure includes a graphene oxide composite. The graphene oxide composite includes two graphene oxides and a polymer arranged between the graphene oxides. For one graphene oxide composite, one or more polymers may be arranged.

According to an embodiment, the composite cation exchange membrane may include multiple layers of graphene oxide composites. That is, a graphene oxide composite is one unit, and multiple graphene oxide composites may be arranged in a composite cation exchange membrane. In this specification, “two graphene oxides” are described to explain a graphene oxide composite, but since each graphene oxide in the two graphene oxides has no difference in composition, it is also described as “graphene oxide” below.

According to an embodiment, a polymer may be cross-linked to two graphene oxides, and the cross-linking may be a covalent bond between a diamine grafted to the graphene oxides and a cross-linking agent bonded to the polymer. That is, the polymer may be cross-linked through chemical bonding to graphene oxide, and to bond them, diamine may be grafted to graphene oxide, and a cross-linking agent may be bonded to the polymer. The above graft means a reaction of attaching diamine to a graphene oxide that becomes a stem, which has the same meaning as grafting. Diamine can be grafted onto an epoxide of graphene oxide through a ring-opening reaction. If a composite cation exchange membrane is manufactured without diamine, there is a high possibility that graphene oxide and the polymer will not complete a covalent bond and will exist only through a hydrogen bond. Since both graphene oxide and the polymer are hydrophilic, a problem of redispersion in water may occur. Therefore, diamine acts as an intermediate bridge between graphene oxide and the polymer, allowing easy covalent bonding even at room temperature, thereby structurally stabilizing the composite cation exchange membrane.

According to an embodiment, the polymer may control the cation selectivity of the composite cation exchange membrane by including an ion exchanger. That is, the crosslinked polymer may contain a large amount of ion exchanger, the ion exchanger may be specifically a carboxyl group, and the anion exchanger of the negatively charged polymer enhances the selectivity for cations. Therefore, a graphene oxide membrane crosslinked with the crosslinked polymer containing a large amount of ion exchanger increases the ion exchange performance, compared to a graphene oxide membrane without polymer crosslinking.

According to an embodiment, the two graphene oxides are reduced graphene oxides, and a composite cation exchange membrane including the reduced graphene oxides may have controlled water dispersibility. The reduced graphene oxide means that the oxygen functional group contained in the graphene oxide is in a reduced form. Specifically, the oxygen functional group may be an unreacted oxygen functional group in which the crosslinking reaction of a polymer has not occurred, i.e., a diamine has not been grafted. Graphene oxide contains numerous oxygen functional groups, and thus, graphene oxide-based cation exchange membranes have the disadvantage of being easily dispersed in water. To control the dispersibility in water, the composite cation exchange membrane according to one embodiment of the present disclosure may be made to include only reduced oxygen functional groups through post-processing. The reduced composite cation exchange membrane may have reduced dispersibility in water, thereby maintaining mechanical stability even in water.

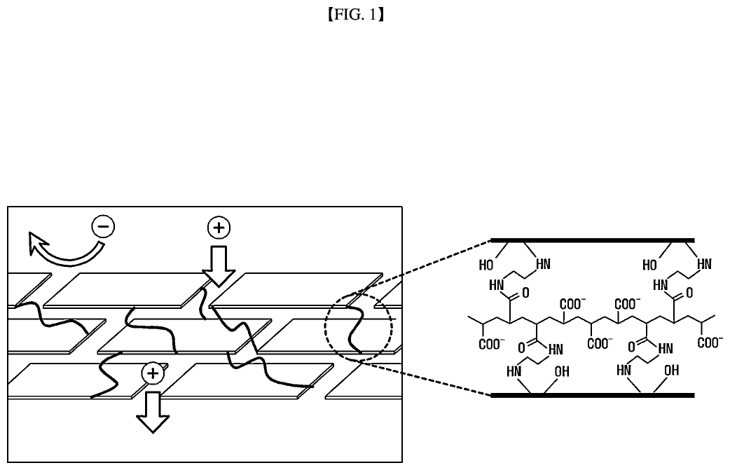

FIG. 1 illustrates a schematic diagram of a polymer-crosslinked composite cation exchange membrane. Referring to FIG. 1, the composite cation exchange membrane may have a thin membrane form in which multiple layers of continuously arranged graphene oxide-based composites are laminated. The circled part is an enlargement of one graphene oxide composite, a polymer is positioned between one graphene oxide and another graphene oxide arranged vertically, and the polymer may be cross-linked to each of the upper and lower graphene oxides. In addition, referring to FIG. 1, a cation indicated as (+) can move into the gap between the graphene oxide composites and permeate the composite cation exchange membrane, but an anion indicated as (−) cannot permeate the composite cation exchange membrane. Since the carboxyl group of the crosslinked polymer is negatively charged, the composite cation exchange membrane may selectively restrict only the permeation of anions using electrostatic forces.

According to an embodiment, the polymer includes a carboxyl group, and in the cross-linking agent bonded to the polymer, the cross-linking agent may be bonded to the carboxyl group. That is, the carboxyl group included in the polymer is a site where the cross-linking agent is attached and, at the same time, may act as a functional group for cation exchange.

According to an embodiment, a composite cation exchange membrane may be in a thin membrane form, and may have a thickness of 5 μm to 10 μm. That is, the composite cation exchange membrane according to an embodiment of the present disclosure is much thinner than a general commercial ion exchange membrane such as an organic membrane (a polymer membrane), so that the volume may be minimized and the manufacturing cost may be reduced. When the thickness of the composite cation exchange membrane is less than 5 μm, it is too thin and has weak mechanical strength, so it is not suitable for use as a water treatment filter, fuel cell, etc., as there is a high risk of damage during use. When the thickness of the composite cation exchange membrane exceeds 10 μm, the electrical resistance increases, making it unsuitable for use in an electrodialysis device when considering electrochemical characteristics.

According to an embodiment, a spacing between the two graphene oxides may be 0.35 nm to 1 nm. Preferably, the spacing between the two graphene oxides may be 0.5 nm to 1 nm. When the membrane is made of only graphene oxide, it is not suitable for use as an ion exchange membrane because the membrane is easily dispersed in water and it is difficult to maintain mechanical stability. In general, to solve these problems, an additional reduction process or a cross-linking agent may be added to maintain stability in water. However, such a chemical crosslinking method or reduction method is accompanied by the elimination of the oxygen functional group of graphene oxide, so that the cation selectivity decreases due to the reduction of anionic groups. When all oxygen functional groups are reduced, graphitization occurs, and the interlayer spacing decreases to 0.34 nm. When the interlayer spacing is narrowed like this, ions may not pass through the membrane, and it may not function as an ion exchange membrane. Therefore, to use it as a cation exchange membrane, it should have an appropriate spacing for ions to move, and it should be manufactured to have sufficient anionic groups to increase the electrostatic repulsion effect with anions, thereby increasing cation selectivity.

According to an embodiment, the diamine may be one or more selected from the group consisting of ethylenediamine (EDA), 1,6-hexanediamine (HDA), triethylenetetramine (TETA) and paraxylylenediamine (PXDA). Preferably, the diamine may be EDA. EDA is the shortest in length among the diamines, so it can implement a thin-thick composite cation exchange membrane with high cation selectivity.

The anionic species contained in the polymer participate in the crosslinking reaction, and the carboxyl group, which did not participate in the reaction, determines the surface charge of the graphene oxide composite, i.e., the surface charge of the composite cation exchange membrane.

According to an embodiment, the polymer may be one or more selected from the group consisting of poly(acrylic acid) (PAA), poly(methacrylic acid), poly(maleic acid) and copolymers thereof. Preferably, the polymer may be PAA. PAA has a high carboxyl group content per unit length while having an appropriate overall length. Accordingly, a composite cation exchange membrane with a high surface charge amount and a high cation selectivity may be realized by increasing the content of carboxyl groups without widening the interlayer spacing of the graphene oxide composite when crosslinked with the graphene oxide.

According to an embodiment, the polymer may have an average molecular weight of 1000 g/mol to 3000 g/mol. When using a polymer having a molecular weight within the range, the manufactured composite cation exchange membrane exhibits excellent electrochemical properties and stability. More specifically, when the average molecular weight of the polymer is less than 1,000 g/mol, there is a problem that the content of carboxyl groups, which determine the surface charge after the polymer is cross-linked, is insufficient. On the other hand, when the average molecular weight of the polymer exceeds 3,000 g/mol, the polymer is too long, which increases the interlayer spacing of the graphene oxide composite. Accordingly, the composite cation exchange membrane with increased thickness may have a problem of decreased cation selectivity.

According to an embodiment, the cross-linking agent may be a zero-length cross-linking agent. The zero-length cross-linking agent refers to a cross-linking agent that can achieve cross-linking without introducing a spacer molecule. By using the zero-length cross-linking agent, it is possible to easily react and complete a chemical bond even at room temperature compared to a general cross-linking agent, and since the length does not increase after the reaction, it is possible to prevent an interlayer spacing from being unnecessarily increased due to a cross-linking agent located in the middle. Therefore, a thin composite cation exchange membrane may be provided by thinly manufacturing the interlayer spacing of the graphene oxide composite.

In addition, the cross-linking agent may be one or more selected from among 1-ethyl-3-(3-dimethylaminopropyl) carbodiimide (EDC) and N-hydroxysuccinimide (NHS).

A method of manufacturing the composite cation exchange membrane according to the present disclosure includes a step of manufacturing diamine-grafted graphene oxide by reacting diamine in a graphene oxide solution, a step of manufacturing a cross-linking agent-bonded polymer by reacting a carboxyl group-containing polymer with a cross-linking agent, a step of manufacturing a polymer-crosslinked graphene oxide by stirring the diamine-grafted graphene oxide and the cross-linking agent-bonded polymer and a step of manufacturing a cation exchange membrane by forming the polymer-crosslinked graphene oxide into a thin membrane. Here, the cation exchange membrane is a composite cation exchange membrane.

Hereinafter, the step of manufacturing diamine-grafted graphene oxide by reacting diamine in a graphene oxide solution is described in more detail.

The graphene oxide solution may be manufactured by dissolving a graphene oxide sheet in deionized water, and the graphene oxide may be manufactured to have a concentration of 3 g/L to 5 g/L.

According to an embodiment, in the step of manufacturing diamine-grafted graphene oxide, a graphene oxide solution may be reacted by stirring diamine at a concentration of 0.1 mM to 1 mM for 30 minutes to 1 hour. Below this range, diamine may not proceed to stitching and its reaction may end in grafting. When the diamine is reacted over the time range, a grafting reaction will change to a stitching reaction. When the stitching reaction occurs, all the amine groups at both ends are consumed, so the site where the polymer will bind disappears. Therefore, by reacting diamine within the time range, one amine group of the diamine may be attached to the graphene oxide, and the other amine group may be attached to the polymer.

According to an embodiment, in the step of manufacturing diamine-grafted graphene oxide, the epoxide of the graphene oxide may be combined with the diamine through a ring-opening reaction.

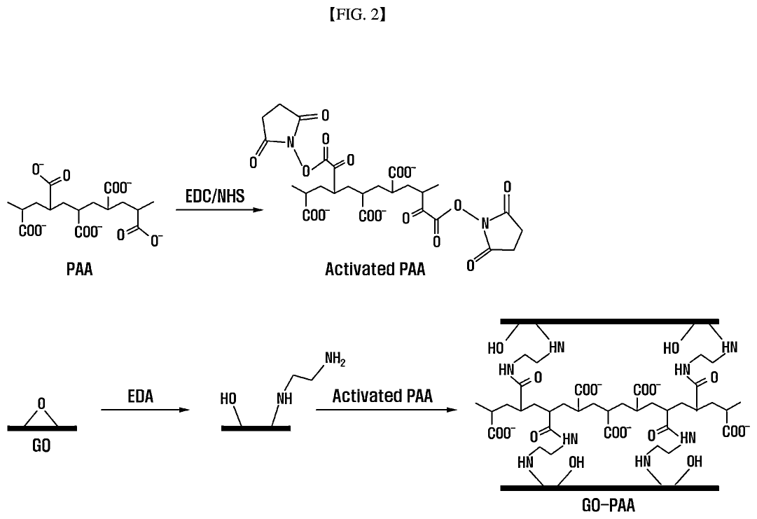

FIG. 2 illustrates a reaction process of graphene oxide cross-linked with a polymer electrolyte. PAA (polymer) reacts with EDS and NHS (a cross-linking agent) to generate activated PAA. Activated PAA is PAA to which a cross-linking agent is bonded, meaning PAA in a state where it can be cross-linked to graphene oxide. A cross-linking agent binds to some carboxyl groups of the polymer. Meanwhile, the epoxide site of GO (graphene oxide) is bonded to diamine through a ring-opening reaction with diamine, and diamine-grafted graphene oxide containing an amine group is generated. The amine group of the grafted graphene oxide reacts with the cross-linking agent bonded to the activated PAA to form a structure (GO-PAA) in which PAA is cross-linked between two graphene oxide layers.

Hereinafter, the step of manufacturing a cross-linking agent-bonded polymer by reacting a carboxyl group-containing polymer with a cross-linking agent is described in more detail.

The step may be performed by adding a cross-linking agent to a polymer solution dispersed in deionized water. Immediately after adding the cross-linking agent to the polymer solution, it appears opaque white, but after sufficient stirring, it changes into a transparent, colorless solution.

The polymer and the cross-linking agent may react in a mass ratio of 1:0.3 to 1:0.6. When the two cross-linking agents are used at the same time, the cross-linking agents may react in the same mole number. For example, when EDC and NHS are used as a cross-linking agent, the polymer and EDC may be prepared in the same mass ratio as above, and NHS may be prepared in the same mole number as EDC.

When manufacturing a composite cation exchange membrane using the cross-linking agent-bonded polymer manufactured in the range, higher cation selectivity in the composite cation exchange membrane may be achieved by highly maintaining the content of the carboxyl group while the polymer may form a stable cross-link with graphene oxide.

The cross-linking agent may be one or more selected from among 1-ethyl-3-(3-dimethylaminopropyl) carbodiimide (EDC) and N-hydroxysuccinimide (NHS). Preferably, 1-ethyl-3-(3-dimethylaminopropyl) carbodiimide (EDC) and N-hydroxysuccinimide (NHS) may be used together as a cross-linking agent.

In the step of manufacturing a cross-linking agent-bonded polymer by reacting a carboxyl group-containing polymer with a cross-linking agent, the polymer containing a carboxyl group may have an average molecular weight of 1000 g/mol to 3000 g/mol. When using the polymer in the same molecular weight range as above, the electrochemical properties and chemical stability of the manufactured composite cation exchange membrane are excellent.

Hereinafter, the step of manufacturing a polymer-crosslinked graphene oxide by stirring the diamine-grafted graphene oxide and the cross-linking agent-bonded polymer is described in more detail.

As described above, whether the cross-linking agent is fully bonded to the polymer can be confirmed through a color change from white to colorless, and it is desirable to slowly dropwise add amine group-grafted graphene oxide to the cross-linking agent-bonded polymer solution where the reaction is complete.

In the step of manufacturing a polymer-crosslinked graphene oxide by stirring the diamine-grafted graphene oxide and the cross-linking agent-bonded polymer, the stirring may be performed at 20° C. to 80° C. for 3 hours to 24 hours. When the stirring is performed at a temperature lower than 20° C. or for less than 3 hours, covalent bonds between diamine and the polymer are not formed well. On the other hand, when the stirring is performed at a temperature higher than 80° C. or for more than 24 hours, graphene oxide may be reduced, and if graphene oxide is reduced at this stage, it cannot form a bond with the polymer.

According to an embodiment, after the step of manufacturing a polymer-crosslinked graphene oxide, a step of purifying a polymer-crosslinked graphene oxide may be further included. The purifying step may be performed to remove a polymer that did not participate in the reaction, thereby producing a graphene oxide composite. The step of purifying a polymer-crosslinked graphene oxide may include a step of centrifuging and precipitating the polymer-crosslinked graphene oxide, a step of dispersing the precipitated polymer-crosslinked graphene oxide in a mixed solution of deionized water and ethanol and centrifuging it and a step of drying the centrifuged polymer-crosslinked graphene oxide. Here, a mixed solution may be prepared by mixing deionized water and ethanol in a volume ratio of 1:1. In addition, the step of centrifuging and precipitating the polymer-crosslinked graphene oxide and the step of dispersing the precipitated polymer-crosslinked graphene oxide in a mixed solution of deionized water and ethanol and centrifuging it may be repeated 5 to 10 times. In addition, in the step of drying the centrifuged polymer-crosslinked graphene oxide, the drying may be performed at a high temperature of 50° C. to 70° C. in a vacuum oven.

Hereinafter, the step of manufacturing a cation exchange membrane by forming the polymer-crosslinked graphene oxide into a thin membrane is described in more detail.

According to an embodiment, in the step of manufacturing a cation exchange membrane, a thin membrane may be formed by one process selected from among natural sedimentation, electro-sedimentation, vacuum filtration method, bar coating, spray coating, dip coating and slot dye coating. Preferably, a thin membrane may be formed by a vacuum filtration method, and this method has the advantage that graphene oxide can be easily formed into a structure in which it is laminated in a plane. The method of forming a thin membrane from the polymer-crosslinked graphene oxide solution that has been purified in this way may be diversified in terms of the speed of thin-membrane production and the uniformity of the thin membrane, and is not specifically limited so long as it is a process that can manufacture a thin membrane based on a solution.

According to an embodiment, in the step of manufacturing a cation exchange membrane, a composite cation exchange membrane is manufactured by vacuum filtration of polymer-crosslinked graphene oxide through a porous membrane, the pore size of the porous membrane may be 0.02 μm to 0.4 μm, and the porous membrane may be one or more selected from among an anodic aluminum oxide membrane, a polyester sulfone membrane and a mixed cellulose ester membrane.

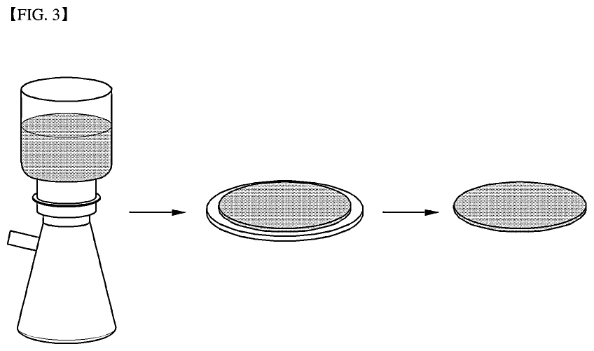

FIG. 3 is a schematic diagram illustrating the manufacturing process of a cation exchange membrane through vacuum filtration. A thin membrane separated from the porous membrane may be used as a self-standing single cation exchange membrane.

According to an embodiment, after the step of manufacturing a cation exchange membrane, a step of reducing graphene oxide by heat-treating the cation exchange membrane may be further included. Here, the heat treatment process may be performed at 80° C. to 100° C. for 3 hours to 24 hours to manufacture a composite cation exchange membrane. By completely drying the polymer cross-linked thin graphene oxide membrane at high temperature in this way, some oxygen functional groups that are contained in the graphene oxide and did not participate in the reaction may be reduced. The graphene oxide containing the reduced oxygen functional groups has very low dispersibility in water, which can prevent the composite cation exchange membrane from dissolving in water.

When the cation exchange membrane is heat-treated at temperatures below 80° C. or for less than 3 hours, reduction may not occur at all. In addition, when the cation exchange membrane is heat-treated at temperatures exceeding 100° C. or for more than 24 hours, excessive reduction occurs, oxygen functional groups are lost and negative charges disappear, so that ions cannot permeate it.

The composite cation exchange membrane manufactured through the process of cross-linking the polymer to the graphene oxide and the additional reduction process is not redispersed in water, maintains an optimized interlayer spacing, i.e., 0.35 nm to 1 nm, preferably 0.5 nm to 1 nm, between graphene oxides, and may provide higher cation selectivity.

Hereinafter, the present disclosure will be described in more detail with reference to the following Examples. It will be apparent to those skilled in the art that the Examples are merely for concretely explaining the disclosure and therefore, there is no intent to limit the disclosure to the Examples.

### [Example 1] Manufacture of Composite Cation Exchange Membrane

### 1. Diamine Grafting on Graphene Oxide

In a flask, 200 mg of graphene oxide was dissolved in 50 ml of deionized water. The graphene oxide was dispersed in deionized water for more than 1 hour using ultrasonic waves, so that a well-dispersed graphene oxide solution was obtained. After adding ethylenediamine (EDA) to the graphene oxide solution at a concentration of 0.5 mM, the solution was stirred at 30° C. for 30 minutes to obtain a diamine-grafted graphene oxide solution.

### 2. Polymer Cross-Linking on Graphene Oxide

In another flask, 1 g of poly(acrylic acid) (PAA) was dissolved in 100 ml of deionized water. After dispersing PAA in deionized water using ultrasound for 1 hour, 300 mg of 1-ethyl-3-(3-dimethylaminopropyl) carbodiimide (EDC) and 100 mg of N-hydroxysuccinimide (NHS) were added thereto. The solution containing EDC and NHS was stirred at 60° C. for 30 minutes. The solution was opaque white immediately after the addition of EDC and NHS, but became a transparent colorless solution after stirring. While maintaining the stirring, the graphene oxide solution grafted with diamine was added dropwise to the colorless solution, and stirred at 30° C. for 12 hours, thereby obtaining a polymer-crosslinked graphene oxide solution.

### 3. Purification of Polymer Cross-Linked Graphene Oxide

The polymer-crosslinked graphene oxide solution was divided into 15 ml conical tubes and centrifuged to precipitate it. After discarding the clear solution formed on the precipitate, deionized water and ethanol were added in a 1:1 ratio and dispersed, and centrifugation was performed again. The solution that floated back up was discarded and the above purification process was repeated 5 times to obtain a sufficiently purified polymer cross-linked graphene oxide precipitate. The precipitate was dried in a 50° C. vacuum oven to obtain a solid of purified polymer cross-linked graphene oxide.

4. Formation of Purified Polymer Cross-Linked Graphene Oxide into Thin Membrane and Oxidization Thereof

15 mg of a dried polymer cross-linked graphene oxide was taken and dissolved in 50 ml of deionized water to prepare a completely dispersed polymer cross-linked graphene oxide solution. An anodic aluminum oxide (AAO) membrane with a diameter of 47 mm and a pore diameter of 0.2 μm was placed on a vacuum filtration device, a polymer cross-linked graphene oxide solution was poured onto the AAO membrane, and vacuum filtration was performed. Through vacuum filtration, all the solvent was removed, and the remaining precipitate was formed in the form of a thin membrane with a thickness of 7 μm on the AAO filter.

The thin membrane could be easily physically removed from the AAO filter, and then completely dried in an 80° C. vacuum oven for 24 hours to manufacture a composite cation exchange membrane whose oxygen functional groups were reduced.

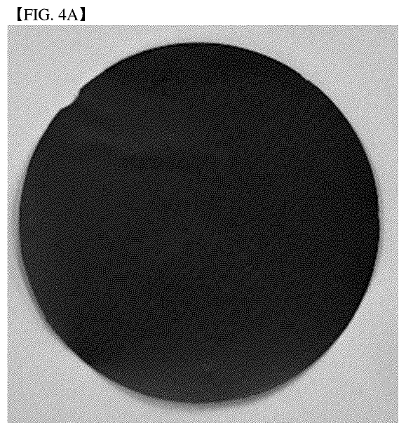

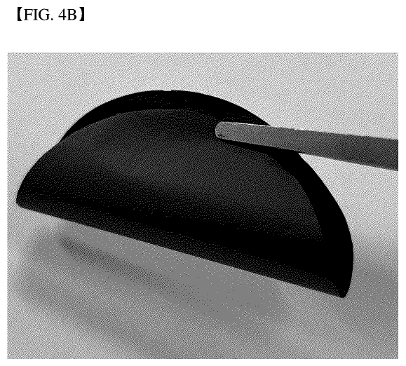

FIGS. 4A and 4B illustrate images of the manufactured composite cation exchange membrane. Referring to FIG. 4B, it can be confirmed that the composite cation exchange membrane is flexible. The composite cation exchange membrane, which has flexibility and can be manufactured thinly to 7 μm and, accordingly, has low electrical resistance, is easily applicable to desalination devices or fuel cells.

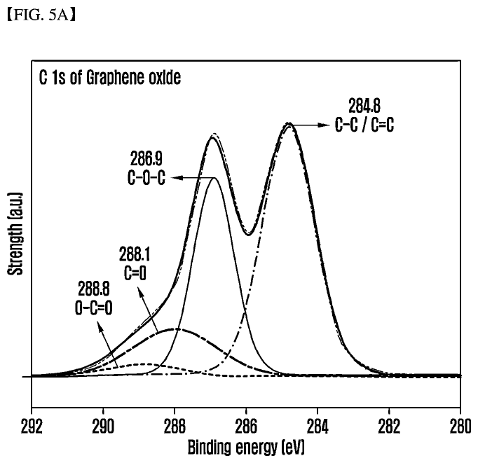

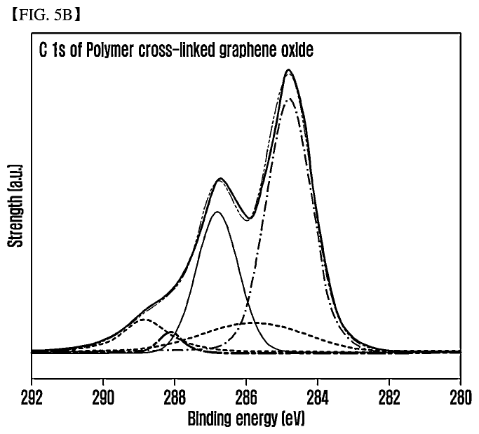

FIGS. 5A and 5B are C 1s spectra of a graphene oxide membrane and Example 1 (a composite cation exchange membrane; referred to as a polymer cross-linked graphene oxide) confirmed by X-ray photoelectron spectroscopy, respectively. Compared to FIG. 5A, FIG. 5B shows a decrease of epoxide (C—O—C) and carbonyl (C═O) at 286.9 eV and 288.1 eV, and an increase of a carboxyl group (O—C═O) peak at 288.8 eV, which confirms that the graft reaction of EDA and the binding of PAA including carboxylic acid have occurred.

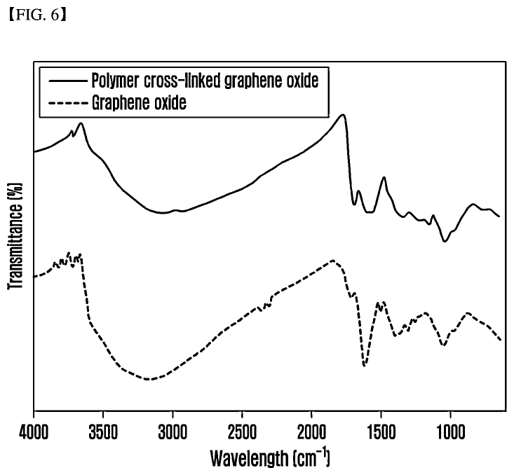

FIG. 6 illustrates the infrared spectroscopy spectra of a graphene oxide membrane and Example 1 (a composite cation exchange membrane; referred to as a polymer cross-linked graphene oxide). Referring to the results of Example 1 in FIG. 6, an increase in a carboxyl group peak can be confirmed at 1727 cm⁻¹ and 1050 cm⁻¹, and the generation of N—H and C—N peaks can be confirmed at 1545 cm⁻¹ and 1356 cm⁻¹, which confirms that the graft reaction of EDA and the binding of PAA including carboxylic acid have occurred.

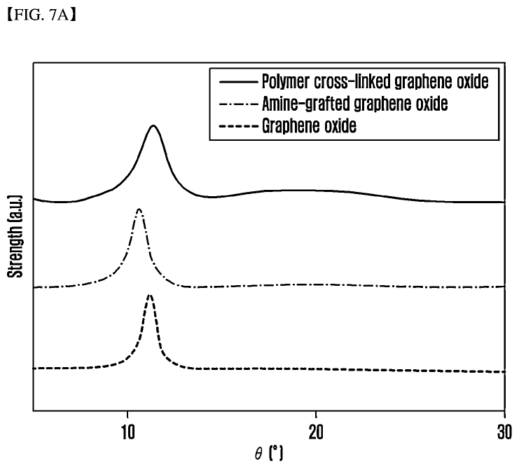

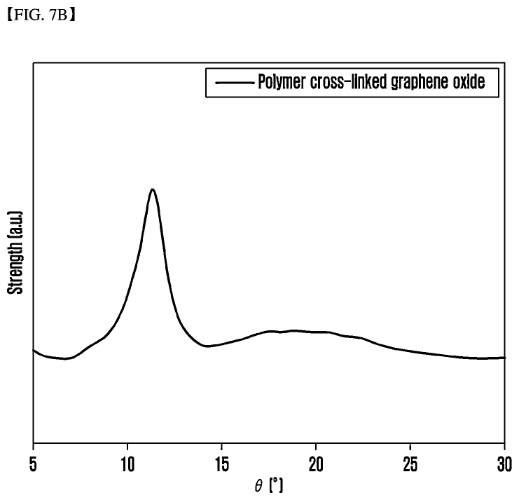

FIG. 7A illustrates the X-ray diffraction results of a graphene oxide membrane, an EDA-grafted graphene oxide membrane (referred to as an amine-grafted graphene oxide) and Example 1 (a composite cation exchange membrane; referred to as a polymer cross-linked graphene oxide). FIG. 7B illustrates the X-ray diffraction results of Example 1 (referred to as a polymer cross-linked graphene oxide) again. The results obtained through X-ray diffraction were applied to Bragg's law to calculate the spacing between the graphene oxide layers. As a result, the spacing between the two graphene oxide layers increased from 0.80 nm to 0.84 nm when EDA was grafted, and then decreased to 0.75 nm after bonding with PAA, confirming that PAA was normally cross-linked to the graphene oxides.

### [Experimental Example 1] Evaluation of Redispersibility of Composite Cation Exchange Membrane in Water

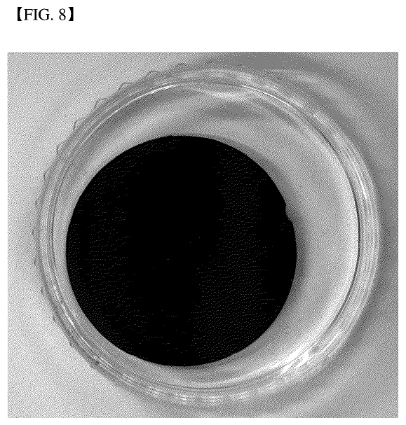

FIG. 8 illustrates an image of a composite cation exchange membrane after a certain time after immersing it in water. 24 hours after immersing the composite cation exchange membrane in water, it was confirmed that the composite cation exchange membrane was not redispersed in water, which means that the manufactured composite cation exchange membrane secured structural stability in water.

### [Experimental Example 2] Performance Evaluation of Composite Cation Exchange Membrane

KCl electrolytes of different concentrations were placed on both sides of Example 1 (a composite cation exchange membrane), and the generated voltage was measured. Here, the low-concentration KCl electrolyte compartment was fixed at 1 mM, and the high-concentration compartment was configured to have a concentration gradient of 10 to 1,000 times, and the test was conducted. The number of transported cations was calculated based on the Nernst equation based on the generation voltage.

Table 1 below shows the results of measuring the ion selectivity of Example 1 (composite cation exchange membrane) under the conditions. Referring to Table 1, the composite cation exchange membrane according to an embodiment of the present disclosure was confirmed to exhibit higher cation selectivity even at a thickness of 7 μm, as a high cation transport number of 0.9 or higher was maintained under the concentration gradient.

TABLE 1

| Electrolyte | | Membrane | |
|---|---|---|---|
| Low | High | potential | Number of |
| concentration | concentration | (mV) | transported cations |
| 1 mM | 0.01M | 47.2 | 0.914 |
| | 0.0316M | 79.4 | 0.967 |
| | 0.1M | 100.6 | 0.952 |
| | 0.316M | 126.7 | 0.960 |
| | 1M | 147.2 | 0.949 |

The composite cation exchange membrane according to the present disclosure can be manufactured to a thickness of 10 μm or less, and has a very thin thickness compared to general commercial ion exchange membranes, thereby having low electrical resistance and flexibility, and being capable of reducing the volume and manufacturing costs when used in desalination devices, fuel cells, etc.

The composite cation exchange membrane according to the present disclosure embodiment includes a composite structure in which a polymer having abundant ion exchange groups is cross-linked, thereby being capable of exhibiting higher cation selectivity even when the thickness is thin, and at the same time, not being easily redispersed in water.

Although the present disclosure has been described through limited examples and figures, the present disclosure is not intended to be limited to the examples. Those skilled in the art will appreciate that various modifications, additions and substitutions are possible, without departing from the scope and spirit of the disclosure. Therefore, it should be understood that there is no intent to limit the disclosure to the embodiments disclosed, rather, the disclosure is to cover all modifications, equivalents, and alternatives falling within the spirit and scope of the disclosure as defined by the claims.

What is claimed is:

1. A composite cation exchange membrane comprising a graphene oxide composite,
wherein the graphene oxide composite comprises two graphene oxides and a polymer arranged between the graphene oxides.

2. The composite cation exchange membrane according to claim 1, wherein the polymer is cross-linked onto the two graphene oxides,
wherein the cross-linking is a covalent bond between a diamine grafted onto the graphene oxide and a cross-linking agent bonded to the polymer.

3. The composite cation exchange membrane according to claim 2, wherein the polymer comprises a carboxyl group,
wherein the cross-linking agent is bonded to the carboxyl group.

4. The composite cation exchange membrane according to claim 1, wherein the composite cation exchange membrane comprises the graphene oxide composite in multiple layers.

5. The composite cation exchange membrane according to claim 1, wherein the composite cation exchange membrane has a thickness of 5 μm to 10 μm.

6. The composite cation exchange membrane according to claim 1, wherein a spacing between the two graphene oxides is 0.35 nm to 1 nm.

7. The composite cation exchange membrane according to claim 1, wherein the polymer has an average molecular weight of 1000 g/mol to 3000 g/mol.

8. The composite cation exchange membrane according to claim 1, wherein the polymer comprises an ion exchanger to control cation selectivity of the composite cation exchange membrane.

9. The composite cation exchange membrane according to claim 1, wherein the two graphene oxides are reduced graphene oxides, and
a composite cation exchange membrane comprising the reduced graphene oxides has controllable water dispersibility.

10. A method of manufacturing a composite cation exchange membrane, the method comprising:
manufacturing diamine-grafted graphene oxide by reacting diamine in a graphene oxide solution;
manufacturing a cross-linking agent-bonded polymer by reacting a carboxyl group-containing polymer with a cross-linking agent;
manufacturing a polymer-crosslinked graphene oxide by stirring the diamine-grafted graphene oxide and the cross-linking agent-bonded polymer; and
manufacturing a cation exchange membrane by forming the polymer-crosslinked graphene oxide into a thin membrane.

11. The method according to claim 10, wherein, in the manufacturing of the diamine-grafted graphene oxide, the graphene oxide solution is stirred and reacted with the diamine at a concentration of 0.1 mM to 1 mM for 30 minutes to 1 hour.

12. The method according to claim 10, wherein, in the manufacturing of the diamine-grafted graphene oxide, an epoxide of the graphene oxide is bonded to the diamine through a ring-opening reaction.

13. The method according to claim 10, further comprising, after the manufacturing of the polymer-crosslinked graphene oxide, purifying the polymer-crosslinked graphene oxide.

14. The method according to claim 10, wherein, in the manufacturing of the cation exchange membrane, the forming of the polymer-crosslinked graphene oxide into a thin membrane is performed by one process selected from among natural sedimentation, electro-sedimentation, vacuum filtration method, bar coating, spray coating, dip coating and slot dye coating.

15. The method according to claim 10, wherein, in the manufacturing of the cation exchange membrane, a composite cation exchange membrane is manufactured by vacuum-filtering the polymer-crosslinked graphene oxide on a porous membrane,
wherein the porous membrane is one or more selected from among an anodic aluminum oxide membrane, a polyester sulfone membrane and a mixed cellulose ester membrane.

16. The method according to claim 10, further comprising, after the manufacturing of the cation exchange membrane, reducing the graphene oxide by heat-treating the cation exchange membrane.
